(19) United States
(12) Patent Application Publication
(10) Pub. No.: US 2022/0199974 A1
(43) Pub. Date: Jun. 23, 2022

(54) ELECTRODE ACTIVE MATERIAL, ALL-SOLID-STATE BATTERY, AND METHOD FOR MANUFACTURING ELECTRODE ACTIVE MATERIAL

(71) Applicant: Panasonic Intellectual Property Management Co., Ltd., Osaka (JP)

(72) Inventors: TOSHIYUKI KOJIMA, Kyoto (JP); AKIHIRO HORIKAWA, Osaka (JP)

(21) Appl. No.: 17/522,968

(22) Filed: Nov. 10, 2021

(30) Foreign Application Priority Data
Dec. 23, 2020 (JP) 2020-213570

(51) Int. Cl. H01M 4/36; H01M 10/0562; H01M 4/04; H01M 10/0585

(52) U.S. Cl. CPC H01M 4/364; H01M 10/0562; H01M 2004/028; H01M 10/0585; H01M 4/043

(57) ABSTRACT

Positive electrode active material 2 is used for positive electrode layer 20 of all-solid-state battery 100, and contains plural secondary particles 2b in each of which plural primary particles 1a are aggregated. Plural of secondary particles 2b contain impregnation particles, the impregnation particles each being a secondary particle having a region impregnated with solid electrolyte 1 in a gap between plural primary particles 1a. The region impregnated with solid electrolyte 1 is a region in which solid electrolyte 1 is impregnated in a distance of 1 μm or more from an outer periphery of the impregnation particle toward an inside of the impregnation particle.

### BACKGROUND

### 1. Technical Field

The present disclosure relates to an electrode active material, an all-solid-state battery, and a method for manufacturing an electrode active material.

### 2. Description of the Related Art

In recent years, development of a secondary battery that can be repeatedly used has been required due to weight reduction, cordless extension, or the like of electronic devices such as personal computers and mobile phones. Examples of the secondary battery include a nickel-cadmium battery, a nickel hydrogen battery, a lead-acid battery, and a lithium ion battery. Among these batteries, the lithium ion battery has characteristics such as a light weight, a high voltage, and a high energy density, and is thus attracting attention.

In an automobile field such as an electric vehicle or a hybrid vehicle, the development of a secondary battery having a high battery capacity is important, and a demand for the lithium ion battery tends to increase.

The lithium ion battery is formed of a positive electrode layer, a negative electrode layer, and an electrolyte disposed between the positive electrode layer and the negative electrode layer, and a solid electrolyte or an electrolyte solution obtained by dissolving a supporting salt such as lithium hexafluorophosphate in an organic solvent is used for the electrolyte. Currently, a widely used lithium ion battery is combustible since the electrolytic solution containing the organic solvent is used. Therefore, a material, a structure, and a system for ensuring the safety of the lithium ion battery are required. On the other hand, it is expected that by using a nonflammable solid electrolyte as the electrolyte, the material, the structure, and the system described above can be simplified, and it is thought that an energy density can be increased, a manufacturing cost can be reduced, and productivity can be improved. Hereinafter, a battery using the solid electrolyte will be referred to as an “all-solid-state battery”.

The solid electrolyte can be roughly divided into an organic solid electrolyte and an inorganic solid electrolyte. In general, as a solid electrolyte to be used for a solid electrolyte layer and a solid electrolyte to be used for forming the positive electrode layer or the negative electrode layer together with an active material, an inorganic solid electrolyte having a high ion conductivity at normal temperature (for example, 25° C.) is mainly used. Examples of the inorganic solid electrolyte include an oxide-based solid electrolyte, a sulfide-based solid electrolyte, and a halide-based solid electrolyte. The ion conductivity of these inorganic solid electrolytes at 25° C. is, for example, about 10⁻⁴ S/cm to 10⁻² S/cm. Japanese Patent Unexamined Publication No. 2020-109747 discloses an all-solid-state battery using an inorganic solid electrolyte in a solid electrolyte layer, a positive electrode layer, and a negative electrode layer.

### SUMMARY

An electrode active material according to an aspect of the present disclosure is an electrode active material that is used for a positive electrode or a negative electrode of an all-solid-state battery and that contains a plurality of secondary particles in each of which a plurality of primary particles are aggregated, in which the plurality of secondary particles contain impregnation particles, the impregnation particles each being a secondary particle having a region impregnated with a solid electrolyte in a gap between the plurality of primary particles, and the region impregnated with the solid electrolyte is a region in which the solid electrolyte is impregnated in a distance of 1 μm or more from an outer periphery of the impregnation particle toward an inside of the impregnation particle.

In addition, a method for manufacturing an electrode active material according to an aspect of the present disclosure is a method for manufacturing an electrode active material used for a positive electrode or a negative electrode of an all-solid-state battery, and the method includes: preparing a material of an electrode active material and a solid electrolyte material, the material of the electrode active material containing a plurality of secondary particles in each of which a plurality of primary particles are aggregated and each of which have voids between the plurality of primary particles therein; mixing the material of the electrode active material and the solid electrolyte material; and performing heat pressing on a mixture of the material of the electrode active material and the solid electrolyte material at a temperature of 60% or more of a melting point of the solid electrolyte material.

### BRIEF DESCRIPTION OF THE DRAWINGS

FIG. 1 is a schematic view showing a cross section of an all-solid-state battery according to an embodiment;

FIG. 2A is a schematic view showing a cross section of a positive electrode active material according to a comparative example;

FIG. 2B is an enlarged view of a dotted line portion IIb in FIG. 2A;

FIG. 3A is a schematic view showing a cross section of a positive electrode active material according to the embodiment;

FIG. 3B is an enlarged view of a dotted line portion Mb in FIG. 3A; and

FIG. 4 is a flowchart of a method for manufacturing a positive electrode active material according to the embodiment.

### DETAILED DESCRIPTION

### History of Obtaining One Aspect of Present Disclosure

When a material composed of secondary particles in which a plurality of primary particles are aggregated is used as a material of an electrode active material such as a positive electrode active material, an energy density of an all-solid-state battery and handleability of the electrode active material can be improved. However, such an electrode active material has a structure in which voids remain between the plurality of primary particles. For example, in a method for manufacturing an all-solid-state battery disclosed in Japanese Patent Unexamined Publication No. 2020-109747, a solid electrolyte and a positive electrode active material used in a positive electrode layer are only dispersed by mixing the respective materials. Therefore, when the positive electrode active material composed of a plurality of secondary particles is used, it is considered that the solid electrolyte is in a state of not entering voids present inside the positive electrode active material and is only supported around the particles of the positive electrode active material.

Therefore, the present inventors have found that, in the electrode active material such as a positive electrode active material composed of a plurality of secondary particles, ion conduction through the solid electrolyte is not possible and the inside of the electrode active material cannot be effectively used, and therefore, there is a problem that it is difficult to effectively use the electrode active material, that is, ions and electrons are less likely to be exchanged. That is, in order to improve battery characteristics such as the energy density of the all-solid-state battery, the ions and the electrons need to be exchanged not only on an outer peripheral surface of the electrode active material but also inside the electrode active material, and it is also necessary to effectively use the inside of the electrode active material.

Thus, in order to improve the battery characteristics in the all-solid-state battery, it is necessary to effectively use the electrode active material contained in the positive electrode layer or a negative electrode layer. The present disclosure has been made in view of the above problems, and provides an electrode active material capable of improving battery characteristics of an all-solid-state battery and an all-solid-state battery using the same. Specifically, the present disclosure provides an electrode active material capable of improving battery characteristics of an all-solid-state battery and an all-solid-state battery using the same, and the like by improving ion conductivity inside the electrode active material.

### Overview of Present Disclosure

An electrode active material according to an aspect of the present disclosure is an electrode active material that is used for a positive electrode or a negative electrode of an all-solid-state battery and that contains a plurality of secondary particles in each of which a plurality of primary particles are aggregated, in which the plurality of secondary particles contain impregnation particles, the impregnation particles each being a secondary particle having a region impregnated with a solid electrolyte in a gap between the plurality of primary particles, and the region impregnated with the solid electrolyte is a region in which the solid electrolyte is impregnated in a distance of 1 μm or more from an outer periphery of the impregnation particles toward an inside of the impregnation particle.

Accordingly, the gap between the plurality of primary particles in the impregnation particles contained in the electrode active material are in a state of being impregnated with the solid electrolyte. Therefore, an ion conduction path is formed inside the impregnation particles. As a result, not only on surfaces of the plurality of secondary particles of the electrode active material, but also inside the impregnation particles contained in the plurality of secondary particles, the ions and the electrons are exchanged by a reaction between the ions carried from the solid electrolyte and the electrons transmitted from the electrode active material. Therefore, the inside of the electrode active material is also effectively utilized, and with the electrode active material, the battery characteristics such as a battery capacity of the all-solid-state battery can be improved.

For example, the solid electrolyte may be a sulfide-based solid electrolyte or a halide-based solid electrolyte.

The sulfide-based solid electrolyte and the halide-based solid electrolyte have a high ion conductivity. Therefore, even in a narrow gap between the plurality of primary particles, the ions are likely to transmit, and thus the inside of the electrode active material is more effectively utilized.

For example, an ion conductivity of the solid electrolyte impregnated in the impregnation particle may be a value of 90% or more of an ion conductivity of the solid electrolyte before being impregnated in the impregnation particle.

Accordingly, a decrease in ion conductivity of the solid electrolyte impregnated in the secondary particles is prevented, and thus the inside of the electrode active material is more effectively utilized.

In addition, an all-solid-state battery according to an aspect of the present disclosure includes a positive electrode or a negative electrode containing the electrode active material.

Thus, since the positive electrode or the negative electrode contains the electrode active material, an all-solid-state battery having improved battery characteristics such as a battery capacity can be obtained.

For example, the positive electrode or the negative electrode containing the electrode active material contains the solid electrolyte that covers the electrode active material.

Accordingly, since the electrode active material is covered with the solid electrolyte the same as the solid electrolyte impregnated in the impregnation particles of the electrode active material, a flow of the ion conduction in the positive electrode or the negative electrode becomes smooth.

In addition, a method for manufacturing an electrode active material according to an aspect of the present disclosure is a method for manufacturing an electrode active material used for a positive electrode or a negative electrode of an all-solid-state battery, and the method includes: preparing a material of an electrode active material and a solid electrolyte material, the material of the electrode active material containing a plurality of secondary particles in each of which a plurality of primary particles are aggregated and each of which have voids between the plurality of primary particles therein; mixing the material of the electrode active material and the solid electrolyte material; and performing heat pressing on a mixture of the material of the electrode active material and the solid electrolyte material at a temperature of 60% or more of a melting point of the solid electrolyte material.

Thus, by performing the heat pressing at a temperature of 60% or more of the melting point of the solid electrolyte material, the material of the solid electrolyte material is softened and is impregnated in the voids of the secondary particles. Accordingly, since the solid electrolyte material is present inside the secondary particles, the ion conductivity inside the secondary particles is improved. Therefore, since the inside of the electrode active material can be effectively utilized in the electrode active material manufactured by the manufacturing method according to the present aspect, it is possible to improve the battery characteristics such as a battery capacity of the all-solid-state battery.

For example, the manufacturing method may further include performing heat pressing on the mixture at a temperature of 80% or more of the melting point of the solid electrolyte material.

Accordingly, since the solid electrolyte material is heat-pressed in a state where the solid electrolyte material is more likely to be softened, the solid electrolyte material is more likely to be impregnated in the voids of the secondary particles.

For example, the solid electrolyte material may be a sulfide-based solid electrolyte or a halide-based solid electrolyte.

Accordingly, since the sulfide-based solid electrolyte or the halide-based solid electrolyte having a high ion conductivity is impregnated in the voids of the secondary particles, the inside of the electrode active material is more effectively utilized.

As described above, the present disclosure can provide an electrode active material capable of improving battery characteristics of an all-solid-state battery and an all-solid-state battery using the same.

Hereinafter, the present embodiment will be described in more detail. Each of the embodiments described below shows a comprehensive or specific example. Numerical values, shapes, materials, constituent elements, arrangement positions and connection forms of the constituent elements, processes, and the like described in the following embodiments are examples, and are not intended to limit the present disclosure. Further, among the constituent elements in the following embodiments, constituent elements not recited in any one of the independent claims are described as optional constituent elements.

Each drawing is a schematic view that is appropriately emphasized, omitted, or adjusted in proportion to show the present disclosure, and is not necessarily exactly illustrated and may differ from an actual shape, positional relationship, and ratio. In the drawings, substantially the same components are denoted by the same reference numerals, and redundant description may be omitted or simplified.

In the present specification, a cross-sectional view is a view showing a cross section in a case where a central portion of the all-solid-state battery in a plan view is cut in a stacking direction (thickness direction of each layer).

### Embodiment

### A. All-Solid-State Battery

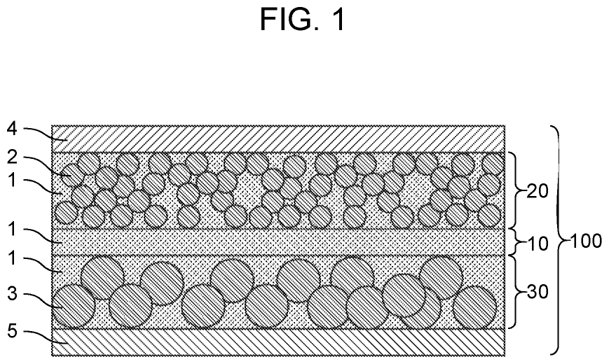

The all-solid-state battery according to the present embodiment will be described with reference to FIG. 1. FIG. 1 is a schematic view showing a cross section of all-solid-state battery 100 according to the present embodiment. All-solid-state battery 100 according to the present embodiment includes positive electrode current collector 4, positive electrode layer 20 formed on positive electrode current collector 4 and containing positive electrode active material 2, negative electrode current collector 5, negative electrode layer 30 formed on negative electrode current collector 5 and containing negative electrode active material 3, and solid electrolyte layer 10 disposed between positive electrode layer 20 and negative electrode layer 30 and containing at least solid electrolyte 1 having ion conductivity. All-solid-state battery 100 has a structure in which positive electrode current collector 4, positive electrode layer 20, solid electrolyte layer 10, negative electrode layer 30, and negative electrode current collector 5 are stacked in this order.

In the present specification, positive electrode active material 2 and negative electrode active material 3 are examples of the electrode active material. That is, the electrode active material is used as positive electrode active material 2 of positive electrode layer 20 or as negative electrode active material 3 of negative electrode layer 30 in all-solid-state battery 100. Positive electrode layer 20 is an example of the positive electrode, and negative electrode layer 30 is an example of the negative electrode.

All-solid-state battery 100 is manufactured, for example, by the following manufacturing method. First, positive electrode layer 20 formed on positive electrode current collector 4 made of a metal foil and containing positive electrode active material 2, negative electrode layer 30 formed on negative electrode current collector 5 made of a metal foil and containing negative electrode active material 3, and solid electrolyte layer 10 disposed between positive electrode layer 20 and negative electrode layer 30 and containing solid electrolyte 1 having ion conductivity are formed. Then, pressing is performed from outer sides of positive electrode current collector 4 and negative electrode current collector 5 at, for example, 100 MPa or more and 1000 MPa or less, for example, 400 MPa, to manufacture all-solid-state battery 100.

### B. Solid Electrolyte Layer

First, solid electrolyte layer 10 in the present embodiment will be described. Solid electrolyte layer 10 in the present embodiment contains solid electrolyte 1. As the material of solid electrolyte 1, for example, a sulfide-based solid electrolyte or a halide-based solid electrolyte is used.

A type of the sulfide-based solid electrolyte in the present embodiment is not particularly limited. Examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, since the ion conductivity of lithium is excellent, the sulfide-based solid electrolyte may contain Li, P, and S. The above description of “Li₂S—P₂S₅” means a sulfide-based solid electrolyte using a raw material composition containing Li₂S and P₂S₅, and the same applies to other descriptions.

The halide-based solid electrolyte is a solid electrolyte containing a halide. The halide is, for example, a compound composed of Li, M′, and X′. M′ is at least one element selected from the group consisting of metal elements other than Li and metalloid elements. X′ is at least one element selected from the group consisting of F, Cl, Br, and I. The “metal element” refers to all elements (excluding hydrogen) included in Group 1 to Group 12 in the periodic table, and all elements (excluding B, Si, Ge, As, Sb, Te, C, N, P, O, S, and Se) included in Group 13 to Group 16 in the periodic table. The “metalloid element” represents B, Si, Ge, As, Sb, and Te. For example, M′ may include Y (yttrium). Examples of the halide containing Y include Li₃YCl₆ and Li₃YBr₆.

### C. Positive Electrode Layer

Next, positive electrode layer 20 in the present embodiment will be described. Positive electrode layer 20 in the present embodiment contains solid electrolyte 1 and positive electrode active material 2, and may further contain a binder as necessary. Solid electrolyte 1 covers positive electrode active material 2. Solid electrolyte 1 is impregnated in positive electrode active material 2. A ratio of solid electrolyte 1 to positive electrode active material 2 is, for example, in a range of 50:50 to 5:95 for the solid electrolyte: the positive electrode active material in terms of weight, and may be in a range of 30:70 to 10:90. It is easy to ensure both the ion conduction path and the electron conduction path in positive electrode layer 20 when the ratio is within the range. A conductive aid such as acetylene black or Ketjen black (registered trademark) may be added to positive electrode layer 20.

Positive electrode current collector 4 is made of, for example, a metal foil. As the metal foil, for example, a metal foil of stainless steel (SUS), aluminum, nickel, titanium, copper, or the like is used.

### C-1. Solid Electrolyte

As solid electrolyte 1 contained in positive electrode layer 20, for example, solid electrolyte 1 the same as solid electrolyte 1 contained in solid electrolyte layer 10 described above in B. Solid Electrolyte Layer is used, and thus the description thereof will be omitted. Solid electrolyte 1 contained in positive electrode layer 20 is made of, for example, a sulfide-based solid electrolyte or a halide-based solid electrolyte. Different types of solid electrolytes may be used for solid electrolyte 1 contained in positive electrode layer 20 and solid electrolyte 1 contained in solid electrolyte layer 10.

### C-2. Positive Electrode Active Material

Positive electrode active material 2 in the present embodiment will be described. For example, a lithium-containing transition metal oxide is used as the material of positive electrode active material 2 in the present embodiment. Examples of the lithium-containing transition metal oxide include LiCoO₂, LiNiO₂, LiMn₂O₄, LiCoPO₄, LiNiPO₄, LiFePO₄, LiMnPO₄, and a compound obtained by substituting the transition metal of the above compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compound obtained by substituting the transition metal of the above compounds with one or two different elements. The materials used for positive electrode active material 2 may be used alone or in combination of two or more thereof.

The material of positive electrode active material 2 is used in a form of being molded into, for example, spherical secondary particles having a particle diameter of 1 μm or more and 100 μm or less by aggregating and granulating a plurality of primary particles. That is, positive electrode active material 2 contains a plurality of secondary particles in which a plurality of primary particles are aggregated. When a particle diameter of the positive electrode active material is miniaturized in order to improve the energy density of the electrode, handleability in an electrode forming step is reduced. Therefore, by granulating a plurality of primary particles finely to a particle diameter of about submicron and using positive electrode active material 2 in a form of the secondary particles in which the plurality of primary particles are aggregated, both the energy density and the handleability can be achieved. However, positive electrode active material 2 thus formed has a structure in which voids remain between the plurality of primary particles. For example, the solid electrolyte used in the all-solid-state battery described in Japanese Patent Unexamined Publication No. 2020-109747 is in a state where, even when the positive electrode active material is composed of the plurality of secondary particles, the solid electrolyte does not enter the voids present inside the positive electrode active material, and is only supported around the particles of the positive electrode active material. Therefore, the ion conduction through the solid electrolyte is not possible inside the positive electrode active material, and the inside of the positive electrode active material cannot be effectively used.

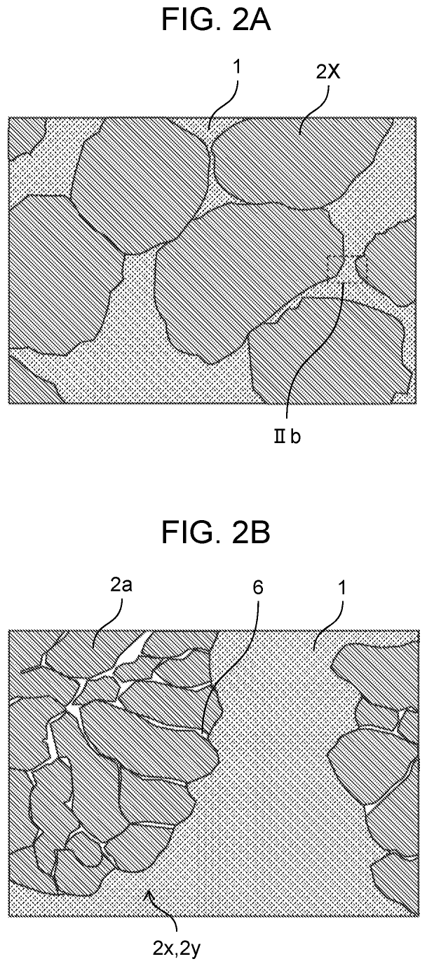

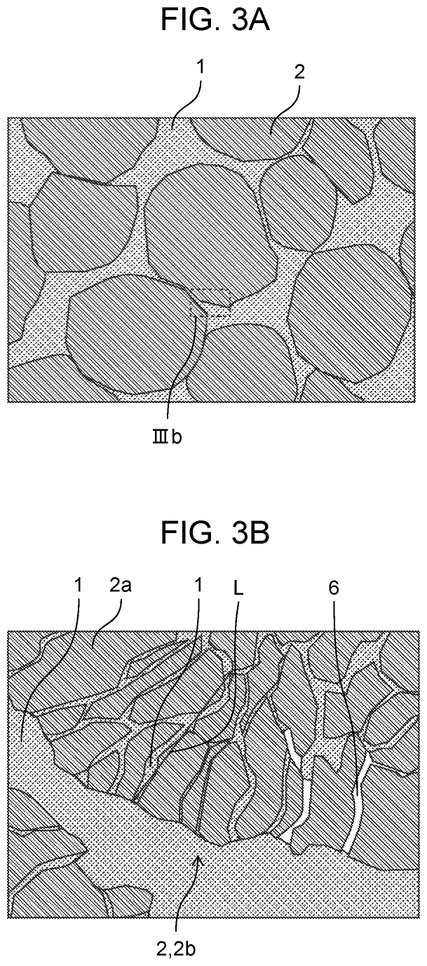

Here, a state where the electrode active material is impregnated (in other words, filled) with the solid electrolyte will be described with reference to FIGS. 2A and 2B, FIGS. 3A and 3B. As the electrode active material, the positive electrode active material will be described as an example, but the same effect is obtained in the negative electrode active material.

FIGS. 2A and 2B are schematic views showing cross sections of positive electrode active material 2x according to a comparative example. FIG. 2A is a cross-sectional view of plural positive electrode active materials 2x in the positive electrode layer, and FIG. 2B is an enlarged view of a dotted line portion IIb in FIG. 2A. As illustrated in FIG. 2B, positive electrode active material 2x contains secondary particles 2y in which plural primary particles 2a are aggregated. Voids 6 are present between primary particles 2a of positive electrode active materials 2x. Thus, inside positive electrode active material 2x according to the comparative example, an active material region, which is a region in which plural primary particles 2a are present, and voids 6 are present. Therefore, the ion conduction through solid electrolyte 1 is not possible inside positive electrode active material 2x, and the inside of positive electrode active material 2x cannot be effectively used.

FIGS. 3A and 3B are schematic views showing cross sections of positive electrode active material 2 according to the present embodiment. FIG. 3A is a cross-sectional view of plural positive electrode active materials 2 in the positive electrode layer, and FIG. 3B is an enlarged view of a dotted line portion IIIb in FIG. 3A.

In order to solve the above problem, as illustrated in FIG. 3B, positive electrode active material 2 according to the present embodiment contains secondary particles 2b in which plural primary particles 2a are aggregated. In positive electrode active material 2, for example, solid electrolyte 1, which is made of the same material as that of solid electrolyte 1 used in positive electrode layer 20, is impregnated (in other words, filled) in portions of voids 6 of plural secondary particles 2b. That is, plural secondary particles 2b contained in positive electrode active material 2 contain impregnation particles, which are secondary particles 2b having an impregnation region, which is a region in which solid electrolyte 1 is impregnated in the gap between plural primary particles 2a, and an active material region, which is a region in which plural primary particles 2a are present. As described above, solid electrolyte 1 is made of, for example, the sulfide-based solid electrolyte or the halide-based solid electrolyte. Plural secondary particles 2b may contain secondary particles 2b not impregnated with solid electrolyte 1.

Thus, in positive electrode active material 2, unlike positive electrode active material 2x, there is almost no void 6 in the impregnation particles contained in positive electrode active material 2. That is, the impregnation particles contained in positive electrode active material 2 in the present embodiment shown in FIG. 3B have the impregnation region in which solid electrolyte 1 is impregnated in a portion corresponding to voids 6 of positive electrode active materials 2x.

Accordingly, the gap between primary particles 2a of positive electrode active material 2 is in a state of being impregnated with solid electrolyte 1. Therefore, the inside of the impregnation particles, which are secondary particles 2b impregnated with solid electrolyte 1, has a structure having an ion conduction path. As a result, not only on the surfaces of plural secondary particles 2b, but also inside plural secondary particles 2b (specifically, inside the impregnation particles), the ions and the electrons are exchanged by the reaction between the ions carried from solid electrolyte 1 and the electrons transmitted from primary particles 2a of positive electrode active material 2. Therefore, the inside of positive electrode active material 2 is effectively utilized, and the battery characteristics such as a battery capacity of all-solid-state battery 100 are improved.

Further, positive electrode layer 20 containing positive electrode active material 2 contains solid electrolyte 1 impregnated with the impregnation particles, and solid electrolyte 1 covering positive electrode active material 2. That is, solid electrolyte 1 impregnated in the impregnation particles in positive electrode active material 2 is used for positive electrode layer 20, and is the material the same as solid electrolyte 1 having good ion conductivity for covering positive electrode active material 2. Therefore, the inside of positive electrode active material 2 is more effectively used. In addition, since the same material is used for solid electrolyte 1 impregnated in the impregnation particles and solid electrolyte 1 covering positive electrode active materials 2, the flow of the ion conduction is also smooth.

Specific examples of solid electrolyte 1 impregnated in the impregnation particles in the present embodiment include a sulfide-based solid electrolyte and a halide-based solid electrolyte. Since the sulfide-based solid electrolyte and the halide-based solid electrolyte have a high ion conductivity, the ions are likely to be transmitted even in the narrow gap between plural primary particles 2a, the inside of positive electrode active material 2 is more effectively utilized.

Further, the sulfide-based solid electrolyte and the halide-based solid electrolyte generally have an ion conductivity higher than that of a polymer solid electrolyte that is likely to be melt-impregnated. Therefore, even when the same material is used for solid electrolyte 1 impregnated in the impregnation particles and solid electrolyte 1 covering positive electrode active material 2, the ion conductivity of entire positive electrode layer 20 is likely to be improved while effectively using the inside of positive electrode active material 2.

In addition, the impregnation particles have a portion in which distance L in which solid electrolyte 1 is impregnated from the outer periphery of the impregnation particles toward the inside thereof is 1 μm or more, as indicated by arrows in FIG. 3B. That is, the impregnation region in which the impregnation particles are impregnated with solid electrolyte 1 is a region impregnated with solid electrolyte 1 by 1 μm or more from the outer periphery of the impregnated particles toward the inside thereof.

Accordingly, a relatively wide region inside the impregnation particles has a structure having an ion conduction path. Therefore, in the relatively wide region inside the impregnation particles, the ions and the electrons are exchanged by the reaction between the ions carried from solid electrolyte 1 and the electrons transmitted from primary particles 2a of positive electrode active material 2. Therefore, the inside of positive electrode active material 2 is effectively utilized, and the battery characteristics such as a battery capacity of all-solid-state battery 100 are improved.

Since the impregnation particles have the impregnation region impregnated with solid electrolyte 1 by 1 μm or more from the outer periphery of the impregnation particles toward the inside thereof, for example, when the particle diameters of the impregnation particles are 5 μm, the impregnation region occupies 48% of a volume of the impregnation particles, the battery characteristics such as a battery capacity of all-solid-state battery 100 are improved.

Further, since the impregnation particles have the impregnation region impregnated with solid electrolyte 1 by 2 μm or more from the outer periphery of the impregnation particles toward the inside, for example, when the particle diameters of the impregnation particles are 5 μm, the impregnation region occupies 93% of the volume of the impregnation particles, and thus the battery characteristics such as the battery capacity of all-solid-state battery 100 are further improved.

Therefore, a ratio of distance L to the particle diameter of the impregnation particles may be 20% or more and 50% or less, or 40% or more and 50% or less.

Further, the ion conductivity of solid electrolyte 1 impregnated in the impregnation particles may be, for example, a value of 90% or more of the ion conductivity of the solid electrolyte before being impregnated in the impregnation particles.

The solid electrolyte material such as a sulfide-based solid electrolyte and a halide-based solid electrolyte is likely to be deteriorated by a reaction with water. For example, when a method of melting the solid electrolyte in a solvent and impregnating the solid electrolyte is used, the solid electrolyte is deteriorated by moisture remaining in the solvent. In addition, it is also possible to melt the solid electrolyte in a supercritical fluid, but also in this case, the solid electrolyte is deteriorated by moisture remaining in the supercritical fluid. Accordingly, the ion conductivity of the solid electrolyte is likely to decrease.

Therefore, for example, by using a method in which the solid electrolyte material is pressed together with the material of the positive electrode active material at a temperature close to the melting point of the solid electrolyte material and impregnated in the material of the positive electrode active material, the decrease in ion conductivity of the solid electrolyte material can be prevented, and the ion conductivity of solid electrolyte 1 can be set to a value of 90% or more of the ion conductivity of the solid electrolyte before being impregnated in the impregnation particles (solid electrolyte material used in solid electrolyte 1). As a result, the inside of positive electrode active material 2 is more effectively utilized, and the decrease in ion conductivity of all-solid-state battery 100 can be prevented.

In addition, by using the method in which the solid electrolyte material is pressed together with the material of the positive electrode active material at a temperature close to the melting point and impregnated with the material of the positive electrode active material, the same material as that of solid electrolyte 1 used in positive electrode layer 20 and having a high ion conductivity for covering positive electrode active materials 2 can be used for solid electrolyte 1 impregnated between plural primary particles 2a of positive electrode active material 2. Therefore, the inside of positive electrode active material 2 can be more effectively utilized as described above.

Hereinafter, the method for manufacturing positive electrode active material 2 will be described in detail.

### C-3. Method for Manufacturing Positive Electrode Active Material

The method for manufacturing a positive electrode active material in the present embodiment is a method for manufacturing positive electrode active material 2 used for positive electrode layer 20.

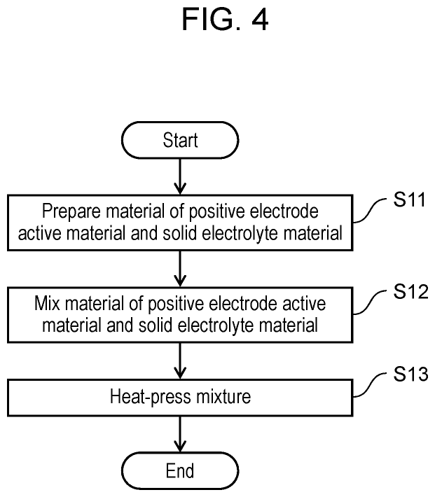

FIG. 4 is a flowchart of the method for manufacturing positive electrode active material 2 according to the present embodiment. The method for manufacturing positive electrode active material 2 includes, for example, step S11, step S12, and step S13 shown in FIG. 4.

First, the material of the positive electrode active material and the solid electrolyte material are prepared, the material of the positive electrode active material containing plural secondary particles 2b in which plural primary particles 2a are aggregated and which have voids 6 between plural primary particles 2a inside plural secondary particles 2b (step S11). The solid electrolyte material is, for example, a sulfide-based solid electrolyte or a halide-based solid electrolyte.

Next, the material of the positive electrode active material and the solid electrolyte material prepared in step S11 are mixed (step S12). Accordingly, a mixture of the material of the positive electrode active material and the solid electrolyte material is obtained. As a method for mixing the material of the positive electrode active material and the solid electrolyte material, a known mixing method can be used, and examples thereof include a method using a mortar and a pestle, and a method using a ball mill. A mixing ratio of the solid electrolyte material and the material of the positive electrode active material is, for example, in the range of 50:50 to 5:95 for the solid electrolyte material: the material of the positive electrode active material in terms of weight, and may be in the range of 30:70 to 10:90.

Next, the mixture of the material of the positive electrode active material and the solid electrolyte material obtained in step S12 is heat-pressed at a temperature of 60% or more of the melting point of the solid electrolyte material (step S13). As a method of heat pressing, a known heat pressing method can be used, and examples thereof include flat pressing, roll pressing, and hot hydrostatic pressing.

By performing the heat pressing at a temperature (Celsius) of 60% or more of the melting point (Celsius) of the solid electrolyte material, the solid electrolyte material can be softened and enter voids 6 between plural primary particles 2a. Thus, the mixture of the material of the positive electrode active material and the solid electrolyte material is heat-pressed to impregnate voids 6 of secondary particles 2b of the material of the positive electrode active material with the solid electrolyte material. Accordingly, positive electrode active material 2 containing the impregnation particles, which are secondary particles 2b having the region impregnated with solid electrolyte 1 in the gap between plural primary particles 2a, is manufactured. In addition, by performing the heat pressing at a temperature (Celsius) of 60% or more of the melting point (Celsius) of the solid electrolyte material, the solid electrolyte material is sufficiently softened, and distance L in which solid electrolyte 1 is impregnated from the outer periphery of the impregnation particles toward the inside thereof is 1 μm or more.

The temperature (Celsius) in the heat pressing may be 80% or more of the melting point (Celsius) of the solid electrolyte material. That is, in step S13, the mixture may be heat-pressed at a temperature of 80% or more of the melting point of the solid electrolyte material. Accordingly, the solid electrolyte material is more likely to be softened, and voids 6 of secondary particles 2b are more likely to be impregnated with the solid electrolyte material. The temperature (Celsius) in the heat pressing is, for example, 130% or less of the melting point (Celsius) of the solid electrolyte material. Accordingly, the deterioration of the solid electrolyte material due to heat is prevented, and the ion conductivity of the solid electrolyte material is less likely to decrease. In the present specification, the melting point is a melting peak temperature measured by differential scanning calorimetry. For example, even when the heat pressing is performed at a temperature of 5% or 40% of the melting point, impregnation of the solid electrolyte material is hardly observed. The temperature in the heat pressing may be equal to or higher than a temperature of an endothermic peak start point of a melting reaction of the solid electrolyte material measured by differential scanning calorimetry.

In addition, the temperature in the heat pressing is lower than, for example, a temperature at which a surface composition of the material of the positive electrode active material is changed.

In the present embodiment, the solid electrolyte material is softened by heating, and voids 6 between plural primary particles 2a are impregnated with the solid electrolyte material, so that the method of melting a solid electrolyte material in a solvent or a supercritical fluid and impregnating the solid electrolyte material is not used. Therefore, the solid electrolyte material can be impregnated in voids 6 between plural primary particles 2a without deteriorating the solid electrolyte due to the residual moisture contained in the solvent or the supercritical fluid. The ion conductivity of the solid electrolyte material after performing the heat pressing (that is, solid electrolyte 1 impregnated in the impregnation particles) is, for example, a value of 90% or more of the ion conductivity of the solid electrolyte material before performing the heat pressing.

A pressure in the heat pressing is, for example, 100 MPa or more and 1000 MPa or less. When the pressure in the heat pressing is 100 MPa or more, the solid electrolyte material is easily impregnated in voids 6. In addition, when the pressure of the heat pressing is 1000 MPa or less, problems such as cracking of the material of the positive electrode active material are prevented. From the viewpoint of further preventing the problems such as cracking of the material of the positive electrode active material, the pressure in the heat pressing may be 100 MPa or more and 350 MPa or less.

As described above, by using positive electrode active materials 2 in the present embodiment, solid electrolyte 1 impregnated in voids 6 remaining in secondary particles 2b functions as the ion conduction path. Accordingly, not only on the surfaces of plural secondary particles 2b, but also inside secondary particles 2b impregnated with solid electrolyte 1, the ions and the electrons are exchanged by the reaction between the ions carried from solid electrolyte 1 and the electrons transmitted from primary particles 2a of positive electrode active material 2. Therefore, all-solid-state battery 100 in which the inside of positive electrode active material 2 is effectively utilized and the battery characteristics such as battery capacity are improved can be provided.

### D. Negative Electrode Layer

Next, negative electrode layer 30 in the present embodiment will be described. Negative electrode layer 30 in the present embodiment may include solid electrolyte 1 and negative electrode active material 3, and may further contain a binder as necessary. Solid electrolyte 1 covers negative electrode active material 3. The ratio of solid electrolyte 1 and negative electrode active material 3 is, for example, in a range of 5:95 to 60:40 for the solid electrolyte: the negative electrode active material in terms of weight, and may be in a range of 30:70 to 50:50. It is easy to ensure both the ion conduction path and the electron conduction path in negative electrode layer 30 when the ratio is within the range. A conductive aid such as acetylene black or Ketjen black may be added to negative electrode layer 30.

As negative electrode current collector 5 made of a metal foil, for example, a metal foil such as stainless steel (SUS), copper, or nickel is used.

### D-1. Solid Electrolyte

As solid electrolyte 1 contained in negative electrode layer 30, for example, solid electrolyte 1 the same as solid electrolyte 1 contained in solid electrolyte layer 10 and solid electrolyte 1 contained in positive electrode layer 20 is used, and therefore the description thereof will be omitted. As solid electrolyte 1 contained in negative electrode layer 30, a type of solid electrolyte different from solid electrolyte 1 contained in solid electrolyte layer 10 and solid electrolyte 1 contained in positive electrode layer 20 may be used.

### D-2. Negative Electrode Active Material

Negative electrode active material 3 in the present embodiment will be described. As the material of negative electrode active material 3 in the present embodiment, for example, known materials such as an easily alloyed metal with lithium such as indium, tin, and silicon, a carbon material such as hard carbon and graphite, lithium, or Li₄Ti₅O₁₂ and SiOₓ are used.

Similar to positive electrode active material 2, negative electrode active material 3 may contain a plurality of secondary particles in which a plurality of primary particles are aggregated. In addition, the plurality of secondary particles of negative electrode active material 3 may contain impregnation particles in which solid electrolyte 1 is impregnated between the plurality of primary particles. A case where negative electrode active material 3 contains the impregnation particles is described by replacing positive electrode active material 2 and the material of the positive electrode active material described in the above C-2. Positive Electrode Active Material and C-3. Method for Manufacturing Positive Electrode Active Material with negative electrode active material 3 and the material of the negative electrode active material. When the plurality of secondary particles of negative electrode active material 3 contain the impregnation particles, the plurality of secondary particles of positive electrode active material 2 may contain the impregnation particles or may not contain the impregnation particles.

### Other Embodiments

The present disclosure is not limited to the above embodiments. The above embodiment is an example, within the scope of the claims of the present disclosure, any object having substantially the same structure as the technical idea and having the same effect and effect is included in the technical scope of the present disclosure. In addition, embodiments in which a person skilled in the art applies various modifications to the embodiments and other forms that are constructed by combining some of the components in the embodiments are also included in the scope of the present disclosure within a range not departing from the gist of the present disclosure.

The electrode active material and the all-solid-state battery according to the present disclosure are expected to be applied to various batteries, such as a power source of a mobile electronic device, and an in-vehicle battery.

What is claimed is:

1. An electrode active material that is used for a positive electrode or a negative electrode of an all-solid-state battery, the electrode active material comprising:
a plurality of secondary particles in each of which a plurality of primary particles are aggregated, wherein
the plurality of secondary particles contain impregnation particles, the impregnation particles each being a secondary particle having a region impregnated with a solid electrolyte in a gap between the plurality of primary particles, and
the region impregnated with the solid electrolyte is a region in which the solid electrolyte is impregnated in a distance of 1 μm or more from an outer periphery of the impregnation particle toward an inside of the impregnation particle.

2. The electrode active material of claim 1, wherein
the solid electrolyte is a sulfide-based solid electrolyte or a halide-based solid electrolyte.

3. The electrode active material of claim 1, wherein
an ion conductivity of the solid electrolyte impregnated in the impregnation particle is a value of 90% or more of an ion conductivity of the solid electrolyte before being impregnated in the impregnation particle.

4. An all-solid-state battery, comprising:
a positive electrode or a negative electrode containing the electrode active material of claim 1.

5. The all-solid-state battery of claim 4, wherein
the positive electrode or the negative electrode containing the electrode active material contains the solid electrolyte that covers the electrode active material.

6. A method for manufacturing an electrode active material used for a positive electrode or a negative electrode of an all-solid-state battery, comprising:
preparing a material of an electrode active material and a solid electrolyte material, the material of the electrode active material containing a plurality of secondary particles in each of which a plurality of primary particles are aggregated and each of which have voids between the plurality of primary particles therein;
mixing the material of the electrode active material and the solid electrolyte material; and
performing heat pressing on a mixture of the material of the electrode active material and the solid electrolyte material at a temperature of 60% or more of a melting point of the solid electrolyte material.

7. The method for manufacturing an electrode active material of claim 6, wherein
the heat pressing is performed on the mixture at a temperature of 80% or more of the melting point of the solid electrolyte material.

8. The method for manufacturing an electrode active material of claim 6, wherein
the solid electrolyte material is a sulfide-based solid electrolyte or a halide-based solid electrolyte.
